(19) United States
(12) Patent Application Publication
(10) Pub. No.: US 2018/0139995 A1
(43) Pub. Date: May 24, 2018

(54) METHOD FOR MANUFACTURING THE MUSHROOM KIMCHI, AND THE MUSHROOM KIMCHI MANUFACTURED BY THE METHOD

(71) Applicants: Green Co., Ltd., Cheongdo-gun (KR); Sein Food Co., Ltd., Daegu-si (KR)

(72) Inventor: Jae Eun Kim, Cheongdo-gun (KR)

(21) Appl. No.: 15/361,000

(22) Filed: Nov. 24, 2016

(51) Int. Cl. A23L 19/00; A23L 19/20

(52) U.S. Cl. CPC A23L 19/05; A23V 2002/00; A23L 19/20

(57) ABSTRACT

Provided is a method of manufacturing kimchi including assorted mushrooms as a filling, in which efficacy of the assorted mushrooms is maintained, a color and gloss and a flavor intrinsic to kimchi do not disappear, and a barrier of an unfamiliar taste and odor peculiar to the mushrooms is removed.

### TECHNICAL FIELD

The present invention relates to a method of manufacturing kimchi having assorted mushrooms as a filling, and more particularly, to a method of manufacturing kimchi having a mushroom, in which efficacy of the assorted mushrooms is maintained, a color and gloss and a flavor intrinsic to kimchi do not disappear, and a barrier of an unfamiliar taste and odor peculiar to the mushrooms is removed.

### BACKGROUND OF THE DISCLOSURE

Kimchi is a Korean traditional food in which a cabbage or a radish preserved with salt is mixed with seasonings including red pepper powder, green onion, or garlic, and then fermented. Men and women of all ages eat kimchi as a principal side dish to supplement nutrition.

The kimchi includes various bioactive substances such as carotene, dietary fiber, and a phenolic compound and plays a beneficial role in preventing oxidation, cancer, and high blood pressure. Kimchi which is a traditional Korean fermented food was officially recognized as an international food by CODEX in 2011, and Health, a U.S. magazine specialized to health, has once selected the kimchi as one of the “world five healthy foods.”

This is because the kimchi which is a well-being food has plentiful vitamins (e.g., B1, B2, or C) and minerals (e.g., calcium or potassium) and is also beneficial to digestion while preventing cancer. The kimchi is the best food in the world in terms of both health and taste.

In February, 2008, ten kinds of Korean foods, such as kimchi, fried kimchi, red pepper paste, soybean paste, green tea, red ginseng tea, persimmon punch powder, instant steamed rice, ramen, or a raw food bar, which are developed by Korea Food Research Institute (KFRI) and Korea Atomic Energy Research Institute (KAERI) together with domestic companies, were certified as the “Space Food” which are edible in the International Space Station from Institute for Biomedical Problems (IBMP), Russia.

A mushroom is a generic term indicating a group forming a fruit body having a size recognizable with naked eyes among fungi. The mushroom can be classified into an edible mushroom and a poisonous mushroom that is inedible. The edible mushrooms, unlike poisonous mushrooms, are free of toxicity to human body and indicate the ones that are safely used as a food. The edible mushrooms have also been widely used because of its unique smell, flavor and nutrition. There are 97 kinds of edible mushrooms and 20 kinds of poisonous mushrooms produced in Korea.

The edible mushrooms can be divided into many different species according to its shape and color and have unique efficacy depending on the environment in which it exists or is cultivated.

However, since the edible mushroom has a unique taste and odor and unfamiliar textures, some people such as a child or adolescent who are in the developing or growing phase are reluctant to eat the mushrooms.

Accordingly, the mushrooms are added in the kimchi that everyone eats regardless of an age and sex, so that the efficacy of the mushrooms is maintained while removing the unique taste and odor of the mushroom, helping those people who do not like mushrooms eat by the flavor and taste of the kimchi and ingest effective nutrients of the mushroom.

### SUMMARY OF THE DISCLOSURE

The present invention provides a method of manufacturing kimchi including assorted mushrooms as a filling, in which efficacy of the assorted mushrooms is maintained, a color and gloss and a flavor intrinsic to kimchi do not disappear, and an unfamiliar taste and odor peculiar to the mushrooms are removed.

Embodiments of the present invention provide a method of manufacturing kimchi including a mushroom and the mushroom kimchi manufactured by the method. the method of manufacturing kimchi having a mushroom includes: preparing ingredients including a salted cabbage which is produced using a cabbage and edible salt; preparing a filling produced by mixing the ingredients other than the salted cabbage; inserting the filling into the salted cabbage to manufacture mushroom kimchi; packing the mushroom kimchi manufactured at the inserting of the filling; and ripening the mushroom kimchi packed at the packing at a temperature of 1 to 10° C.

In addition, the salted cabbage is produced by a method including preprocessing the cabbage where the cabbage is preprocessed, cut and washed; salting the cabbage using 2 to 6 parts by weight of edible salt based on 100 parts by weight of the cabbage after the preprocessing; washing the cabbage salted at the salting; and dehydrating the salted cabbage washed at the washing.

In this case, the cabbage is preferably salted to have a salinity of 10 to 17% in winter, 6 to 13% in summer, and 8 to 15% in spring and autumn at the salting.

Also, the dehydrating is achieved naturally for 20 to 28 hours.

Here, the ingredients include 45 to 65% by weight (wt %) of the salted cabbage, 17 to 28 wt % of mushrooms, 3 to 15 wt % of radish shreds, 2 to 8 wt % of red pepper powder, 2 to 7 wt % of kelp stock, 1.5 to 3.5 wt % of garlic, 0.2 to 0.8 wt % of salted shrimps, 1 to 3 wt % of green onion, 1 to 3 wt % of onion, 0.3 to 2 wt % of glutinous rice starch, 0.2 to 1 wt % of ginger, 0.1 to 0.9 wt % of chives, 0.1 to 0.9 wt % of sugar, 0.1 to 0.9 wt % of salt, 0.1 to 0.9 wt % of water dropwort, and 0.1 to 0.9 wt % of L-sodium glutamate.

The mushrooms include 10 to 20 wt % of an enoki mushroom, 10 to 20 wt % of a golden enoki mushroom, 15 to 25 wt % of a king oyster mushroom, 20 to 35 wt % of an oyster mushroom, and 30 to 45 wt % of a white beech mushroom.

In addition, the kelp stock is produced through 3 to 7 wt % of a dried anchovy, 7 to 13 wt % of a radish, 3 to 7 wt % of ground garlic, 1 to 5 wt % of onion, and 70 to 86 wt % of purified water.

### BRIEF DESCRIPTION OF THE DRAWINGS

The accompanying drawings are included to provide a further understanding of the present invention, and are incorporated in and constitute a part of this specification. The drawings illustrate exemplary embodiments of the present invention and, together with the description, serve to explain principles of the present invention. In the drawings:

FIG. 1 is a flowchart illustrating a method of manufacturing kimchi including a mushroom according to an embodiment of the present invention.

### DETAILED DESCRIPTION OF THE PREFERRED EMBODIMENTS

The terms or words used in the following description and claims are not limited to general or dictionary meanings and should be interpreted as having meanings and definitions suitable for the technical sprit of the invention based on a principle that the inventors may suitably define terms to describe the invention in a best mode.

Therefore, an exemplary embodiment stated in the specification and drawings is just a preferably example of the present invention and is not intended to limit the technical spirit of the present invention. Accordingly, it should be construed that various other equivalents and modifications can be made thereto.

Prior to describing the present invention with reference to the accompanying drawing, it is noted that detailed descriptions of well-known functions or configurations are not provided to better describe the gist of the present invention.

The present invention provides a method of manufacturing kimchi including assorted mushrooms as a filling, in which efficacy of the assorted mushrooms is maintained, a color and gloss and a flavor intrinsic to kimchi do not disappear, and an unfamiliar taste and odor by the mushrooms are removed.

Hereinafter, the assorted mushroom according to an embodiment of the present invention is referred to as ‘mushrooms.’

The mushrooms according to an embodiment of the present invention may include an enoki mushroom, a golden enoki mushroom, a king oyster mushroom, an oyster mushroom, and a white beech mushroom.

The mushrooms have following efficacy.

The enoki mushroom is a wild species of Flammulina velvtipes and a kind of mushroom included in Flammulina. It has a pileus of 2-10 cm, and has a semispherical shape at first but becomes a flat shape later. Its color is faintly yellowish brown and it becomes viscous when it is filled with moisture. The corrugation of the pileus is rough and comes in a white or lemon yellow color.

The enoki mushroom contains a sufficient amount of selenium and amino acids that are beneficial to a brain. Thus, it is good for growing children. In addition, it is known to prevent dementia for old people.

Since it contains vitamin B1, the enoki mushroom helps liver cells regenerate, thereby overcoming fatigue. Besides, it facilitates a bowel movement and prevents constipation while reducing visceral fat. It contains a large amount of water and dietary fiber, so it is particularly helpful for a diet. It is also known to improve leucocyte activities due to its glucan content, which enhances body immunity functions and facilitates iron absorption. Finally, gamma-aminobutyric acid (GABA) included therein alleviates stress.

The king oyster mushroom also known as Pleurotus eryngii is a largest species in an oyster mushroom genus, Pleurotus, which is included in Agricaceae.

The king oyster mushroom is full of various nutrients and minerals and has an anticancer effect by preventing cancer cells from being propagated.

Also, a lot of vitamin C and E are contained therein, leading to an excellent antiaging effect. It reinforces functions of a stomach, a bowel, and a liver, playing a significant role in preventing inflammation and constipation while helping overcoming fatigue. Since it also contains lots of water, it effectively inhibits dehydration.

The oyster mushroom also known as Pleurotus ostratus is a mushroom included in Tricholomataceae. It is a genus of gilled mushrooms which include one of the most widely eaten mushrooms. As a species of Pleurotus, Pleurotus ostratus may be called oyster, abalone, or tree mushrooms, and are some of the most commonly cultivated edible mushrooms in the world.

The oyster mushroom is a low-calorie food containing a lot of vitamin B12, niacin, vitamin D2, dietary fiber, and the like and is effective in a diet. It also contains a large amount of ergosterol that is deriving vitamin D2, thus reducing cholesterol and preventing adult diseases like hypertension or diabetes.

In addition, the vitamin B12 facilitates growth and helps digestive absorption of fat, proteins and glucose, thereby preventing dermatitis. Vitamin B12 is also reinforcing a bone structure by vitamin D, preventing osteoporosis and making teeth and bones of a baby stronger.

The oyster mushroom also has a sufficient amount of selenium that is an antioxidation nutrient, potassium regulating a blood pressure, and dietary fibers preventing constipation.

Specifically, the selenium is contained at a rate of 18.4 μg per 100 g of the oyster mushroom, which is 8 times and 12 times larger amount than the selenium contained in carrot and onion, respectively. In addition, since it has potassium that is approximately 90 times more than sodium, it facilitates sodium excretion. Furthermore, due to a flurane ingredient included therein, it is known that the oyster mushroom is beneficial to antitumor, reduction in cholesterol or lumbar pain, while preventing muscle cramps and paralysis in hands and feet.

Finally, it enhances an immune function and prevents cancer cells from being proliferated. Its extracts are known to be effective against breast cancer, lung cancer, liver cancer, as well as any side effects occurring during the cancer treatment, such as vomiting, hair loss, and diarrhea

The white beech mushroom also known as Hypsizygus marmoreus has a diverse efficacy. Specifically, protein polysaccharide obtained by separating and refining an extract of the fruit body of the white beech mushroom is known to have a beneficial effect on inhibiting tumor cell proliferation, particularly solid cancers, and reduce fat contents inside body tissues as well as the sizes of fat cells according to a research result, thereby drawing a lot of attention for the purpose of dietary control.

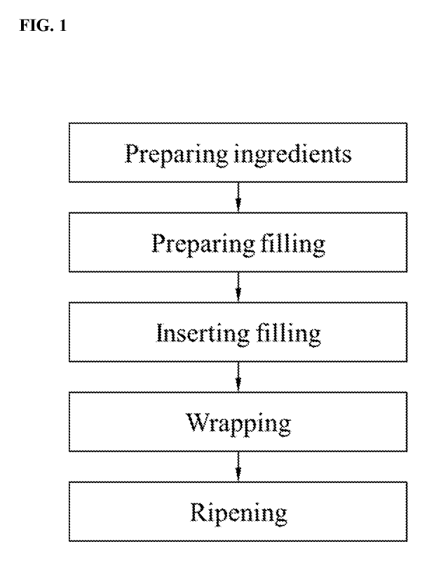

Hereinafter, a method of manufacturing kimchi including a mushroom according to an embodiment of the present invention will be described in detail with reference to FIG. 1. FIG. 1 is a flowchart illustrating the method of manufacturing kimchi including a mushroom.

I. Preparing Ingredients Including a Salted Cabbage

A step of preparing ingredients serves to prepare ingredients including a salted cabbage to manufacture kimchi including a mushroom. The salted cabbage may be prepared by using a cabbage and edible salt.

In addition, the salted cabbage according to an embodiment of the present invention may be prepared as follows.

I-1. Preprocessing

A step of preprocessing serves to remove inedible portions such as yellow leaves of the cabbage, select and wash useful portions that can be used for making kimchi among the ingredients prepared at the step of preparing ingredients, and cut the cabbage into 2 to 4 pieces in a vertical direction to make it easier to salt the cabbage and insert a filling which is described below.

I-2. Salting

A step of salting serves to salt the cabbage cut at the preprocessing step by using edible salt. In this case, the salting may be conducted by sprinkling 2 to 6 parts by weight of salt based on 100 parts by weight of the cabbage.

Also, the cabbage may be preferably salted to have a salinity of 10 to 17% in winter, 6 to 13% in summer, and 8 to 15% in spring and autumn at this salting step.

Since a temperature and humidity are relatively high in summer as compared with other seasons, when the cabbage is salted during summer to have the same salinity as the salinity during winter, the cabbage softens up. In contrast, the temperature and humidity are relatively low in winter as compared with other seasons and thus, it is required to increase the salinity of the salt to facilitate the cabbage salting. In other words, the salinity remains low in summer but high in winter with respect to the salinity of other seasons.

The salting may be performed for 14 to 25 hours.

I-3. Washing

A step of washing serves to wash the cabbage salted at the salting step 3 to 4 times using drinking water or tap water.

I-4. Dehydrating

A step of dehydrating serves to dehydrate the salted cabbage washed at the washing step for 20 to 28 hours naturally without using any artificial means.

The ingredients for the kimchi including a mushroom according to an embodiment of the present invention may include 45 to 65 wt % of the salted cabbage, 17 to 28 wt % of mushrooms, 3 to 15 wt % of radish shreds, 2 to 8 wt % of red pepper powder, 2 to 7 wt % of kelp stock, 1.5 to 3.5 wt % of garlic, 0.2 to 0.8 wt % of salted shrimps, 1 to 3 wt % of green onion, 1 to 3 wt % of onion, 0.3 to 2 wt % of glutinous rice starch, 0.2 to 1 wt % of ginger, 0.1 to 0.9 wt % of chives, 0.1 to 0.9 wt % of sugar, 0.1 to 0.9 wt % of salt, 0.1 to 0.9 wt % of water dropwort, and 0.1 to 0.9 wt % of L-sodium glutamate.

In addition, the kelp stock may be produced through 3 to 7 wt % of a dried anchovy, 7 to 13 wt % of a radish, 3 to 7 wt % of ground garlic, 1 to 5 wt % of onion, and 70 to 86 wt % of purified water.

The mushrooms include an enoki mushroom, a golden enoki mushroom, a king oyster mushroom, an oyster mushroom, and a white beech mushroom. Specifically, the mushrooms according to an embodiment of the present invention may include 10 to 20 wt % of the enoki mushroom, 10 to 20 wt % of the golden enoki mushroom, 15 to 25 wt % of the king oyster mushroom, 20 to 35 wt % of the oyster mushroom, and 30 to 45 wt % of the white beech mushroom.

II. Preparing a Filling

A step of preparing a filling serves to prepare the filling for the kimchi having a mushroom. The filling may be produced by mixing mushrooms, radish shreds, red pepper powder, kelp stock, garlic, salted shrimps, green onion, onion, glutinous rice starch, ginger, chives, sugar, salt, water dropwort, L-sodium glutamate, and the like, among the ingredients prepared at the step of preparing ingredients.

The mushrooms may be parboiled in boiling water of 100° C. for 1-2 minutes to sterilize the mushrooms by removing toxic substances therein and also to improve the textures upon eating the kimchi including the mushrooms.

As described above, the mushrooms include an enoki mushroom, a golden enoki mushroom, a king oyster mushroom, an oyster mushroom, and a white beech mushroom. Each of the mushrooms has a predetermined content such that the mushroom can be highly valued and visually identified to further improve the textures of the mushrooms when eating the kimchi. This may be primarily achieved by including relatively heavy mushrooms.

Although the filling can be mixed at a time, in order to maintain the efficacy of the mushroom and to remove the unfamiliar taste and odor by the mushroom, the mixing according to an embodiment of the present invention may be achieved as follows.

II-1. Removing an Unfamiliar Taste and Odor of the Mushroom

The mushrooms, an anchovy fish sauce, salted shrimp, sugar, salt, water dropwort, ginger, and L-sodium glutamate are mixed based on its content. The mixing may be achieved in a form of hand mixing. The mixed ingredients may be ripened at a room temperature for 0.5 to 4 hours.

II-2. Preparing a Basic Filling

A step of preparing a basic filling serves to prepare the basic filing by mixing radish shreds, red pepper powder, kelp stock, garlic, radish juice, green onion, onion, glutinous rice starch, and chives.

III-3. Preparing a Filling for Kimchi

A step of preparing a filling for kimchi serves to prepare the filling for manufacturing kimchi. The filling for kimchi may be prepared by mixing the mushroom compound prepared at the step of removing an unfamiliar taste and odor of the mushroom (B-1) and the basic filling prepared at the step of preparing a basic filling (B-2).

Here, the step of preparing a basic filling may preferably be performed after the step of removing an unfamiliar taste and odor of the mushroom, because the step of removing an unfamiliar taste and odor of the mushroom takes longer time than the step of preparing a basic filling.

III. Inserting a Filling

A step of inserting a filling serves to insert the filling prepared at the step of preparing a filling into the salted cabbage prepared at the step of preparing ingredients.

Here, the way to insert the filling can be performed in substantially the same manner as a typical way to produce conventional kimchi.

However, depending on design conditions, it may be possible to mix approximately 80% of the basic filling when the basic filling is mixed with the mushroom compound at the step of preparing a filling, while reserving approximately 20% thereof. At the step of inserting a filling, the about 20% of the reserved basic filling may be first inserted into the salted cabbage to make basic-state kimchi and the filling prepared at the step of preparing a filling may be inserted about 1 to 3 hours later.

This is because the texture of the mushrooms included in the mushroom compound may be further improved by mixing the filling including the mushroom compound after ripening the basic-state kimchi for 1 to 3 hours

IV. Packing

A step of packing serves to pack the mushroom kimchi produced at the step of inserting a filling, based on various predetermined sizes (e.g., 200 g, 300 g, 500 g, or 1 to 100 kg).

V. Ripening

A step of ripening serves to ripen the kimchi packed at the packing step at a low temperature of 1 to 10° C. The time for ripening may be ranged from about 3 days up to a year.

An important point of the present invention is described in the above description with reference to the accompanying drawing, and various other designs or modifications are possible without departing from the technical scope of the present invention. Accordingly, the present invention is not limited to the configuration shown in the drawing.

1. A method of manufacturing kimchi, the method comprising:
preparing ingredients including a salted cabbage, the salted cabbage produced using a cabbage and edible salt;
preparing a filling by mixing the ingredients other than the salted cabbage;
inserting the filling into the salted cabbage to manufacture kimchi;
packaging the manufactured kimchi; and
fermenting the packaged kimchi at a temperature of 1 to 10° C.,
wherein the ingredients include 45 to 65 wt % of the salted cabbage, 17 to 28 wt % of mushrooms, 3 to 15 wt % of radish shreds, 2 to 8 wt % of red pepper powder, 2 to 7 wt % of kelp stock, 1.5 to 3.5 wt % of garlic, 0.2 to 0.8 wt % of salted shrimps, 1 to 3 wt % of green onion, 1 to 3 wt % of onion, 0.3 to 2 wt % of glutinous rice starch, 0.2 to 1 wt % of ginger, 0.1 to 0.9 wt % of chives, 0.1 to 0.9 wt % of sugar, 0.1 to 0.9 wt % of salt, 0.1 to 0.9 wt % of water dropwort, and 0.1 to 0.9 wt % of L-sodium glutamate,
wherein the mushrooms include 10 to 20 wt % of an enoki mushroom, 10 to 20 wt % of a golden enoki mushroom, 15 to 25 wt % of a king oyster mushroom, 20 to 35 wt % of an oyster mushroom, and 30 to 45 wt % of a white beech mushroom.

2. (canceled)

3. (canceled)

4. The method of claim 1, wherein the kelp stock is produced through 3 to 7 wt % of a dried anchovy, 7 to 13 wt % of a radish, 3 to 7 wt % of ground garlic, 1 to 5 wt % of onion, and 70 to 86 wt % of purified water.

5. The method of claim 1, wherein the salted cabbage is produced by a method comprising:
preprocessing the cabbage where the cabbage is preprocessed, cut and washed;
salting the cabbage using 2 to 6 parts by weight of edible salt based on 100 parts by weight of the cabbage after the preprocessing;
washing the salted cabbage; and
dehydrating the washed cabbage.

6. The method of claim 5, wherein the cabbage is salted to have a salinity of 6 to 17% at the salting.

7. The method of claim 5, wherein the dehydrating is achieved for 20 to 28 hours.

8. Kimchi manufactured by a method comprising:
preparing ingredients including a salted cabbage, the salted cabbage produced using a cabbage and edible salt;
preparing a filling by mixing the ingredients other than the salted cabbage;
inserting the filling into the salted cabbage to manufacture kimchi;
packaging the manufactured kimchi; and
fermenting the packaged kimchi at a temperature of 1 to 10° C.
wherein the ingredients include 45 to 65 wt % of the salted cabbage, 17 to 28 wt % of mushrooms, 3 to 15 wt % of radish shreds, 2 to 8 wt % of red pepper powder, 2 to 7 wt % of kelp stock, 1.5 to 3.5 wt % of garlic, 0.2 to 0.8 wt % of salted shrimps, 1 to 3 wt % of green onion, 1 to 3 wt % of onion, 0.3 to 2 wt % of glutinous rice starch, 0.2 to 1 wt % of ginger, 0.1 to 0.9 wt % of chives, 0.1 to 0.9 wt % of sugar, 0.1 to 0.9 wt % of salt, 0.1 to 0.9 wt % of water dropwort, and 0.1 to 0.9 wt % of L-sodium glutamate,
wherein the mushrooms include 10 to 20 wt % of an enoki mushroom, 10 to 20 wt % of a golden enoki mushroom, 15 to 25 wt % of a king oyster mushroom, 20 to 35 wt % of an oyster mushroom, and 30 to 45 wt % of a white beech mushroom.

9. (canceled)

10. (canceled)

11. The kimchi of claim 8, wherein the kelp stock is produced through 3 to 7 wt % of a dried anchovy, 7 to 13 wt % of a radish, 3 to 7 wt % of ground garlic, 1 to 5 wt % of onion, and 70 to 86 wt % of purified water.

12. The kimchi of claim 8, wherein the salted cabbage is produced by a method comprising:
preprocessing the cabbage where the cabbage is preprocessed, cut and washed;
salting the cabbage using 2 to 6 parts by weight of edible salt based on 100 parts by weight of the cabbage after the preprocessing;
washing the salted cabbage; and
dehydrating the washed cabbage.

13. The kimchi of claim 12, wherein the cabbage is salted to have a salinity of 6 to 17% at the salting.

14. The kimchi of claim 12, wherein the dehydrating is achieved for 20 to 28 hours.
